(19) United States
(12) Patent Application Publication
(10) Pub. No.: US 2026/0265023 A1
(43) Pub. Date: Sep. 10, 2026

(54) CRANE VEHICLE

(71) Applicant: TADANO LTD., Kagawa (JP)

(72) Inventors: Yudai Masuda, Kagawa (JP); Koki Wada, Kagawa (JP)

(21) Appl. No.: 19/134,225

(22) PCT Filed: Nov. 30, 2023
(86) PCT No.: PCT/JP2023/043014

§ 371 Date: May 21, 2026

(30) Foreign Application Priority Data
Dec. 1, 2022 (JP) 2022-192928

(51) Int. Cl. B66C 13/12; B66C 13/44; B66C 23/42; B66C 23/82

(52) U.S. Cl. CPC B66C 13/12; B66C 13/44; B66C 23/42; B66C 23/82; B66C 2700/0371

(57) ABSTRACT

A crane vehicle includes the following: a traveling apparatus; a slewing base supported by the traveling apparatus; a main power unit for traveling and for crane work provided on the traveling apparatus; and an auxiliary power unit that is supported by the slewing base and supplies power to an electronic device supported by the slewing base.

### TECHNICAL FIELD

The present invention relates to a crane vehicle.

### BACKGROUND ART

A rough terrain crane, one example of a crane vehicle, is self-propelled and includes a traveling apparatus, a slewing base, and a boom (including a jib). The traveling apparatus is a vehicle body including equipment for traveling. In addition, the traveling apparatus includes, on a carrier frame serving as the skeleton thereof, an engine that is a power source for traveling and for crane work using a boom, wheels for traveling that transmit power of the engine to a road surface, an outrigger for improving stability during work, and the like. The slewing base is disposed above the traveling apparatus. The slewing base is provided to be rotatable with respect to the traveling apparatus in a horizontal plane. The slewing base is driven by the engine provided in the traveling apparatus.

The boom is provided on the slewing base and rotates with respect to the traveling apparatus together with the slewing base. In addition, the boom raises and lowers a load and moves the load to another position through extension and retraction, rising and falling with respect to the slewing base, and the rotation of the slewing base. In the rough terrain crane, an operator performs a driving operation during traveling and an operation of crane work using the boom, in a control room (cabin) provided on the slewing base (for example, see PTL 1).

### CITATION LIST

### Patent Literature

### PTL 1

Japanese Patent Application Laid-Open No. 2009-208959

### SUMMARY OF INVENTION

### Technical Problem

From the viewpoint of reducing the fuel consumption of the engine, it is required to stop the engine when a rough terrain crane is not traveling or when the crane work is not performed. In addition, from the viewpoint of reducing an environmental load, it is also required to stop the engine from reducing emissions of greenhouse gases such as carbon dioxide (CO₂).

However, when the engine is stopped while the crane work is not performed, an electrical system using the engine as a power source cannot be used. For example, when the engine is stopped, the air conditioning apparatus (air conditioner) in the control room (cabin) of a rough terrain crane and other accessory power supply (such as power supplied to a universal serial bus (USB: registered trademark) terminal) do not receive power and thus cannot be used.

For this reason, for example, during the daytime in midsummer, when the outdoor temperature becomes very high, the temperature inside the cabin also becomes very high, and an appropriate air-conditioning environment is required from the viewpoint of health of the operator in the cabin. In addition, even when the engine is stopped, it may be necessary to use the accessory power supply or the like.

The present invention has been made in view of the above circumstances, and an object thereof is to provide a crane vehicle that can supply necessary power even in a state where an engine for traveling and for crane work is stopped while reducing a fuel consumption and an environmental load.

### Solution to Problem

A crane vehicle according to the present invention included the following:
a traveling apparatus;
a slewing base supported by the traveling apparatus;
a main power unit provided on the traveling apparatus, the main power unit being for traveling and for crane work; and
an auxiliary power unit supported by the slewing base, the auxiliary power unit supplying power to an electronic device supported by the slewing base.

### Advantageous Effects of Invention

With the crane vehicle according to the present invention, it is possible to supply necessary power to devices provided on a slewing base by an auxiliary power unit even in a state where an engine for traveling and for crane work is stopped while reducing a fuel consumption and an environmental load.

### BRIEF DESCRIPTION OF DRAWINGS

FIG. 1 is a perspective view of a rough terrain crane as viewed from the right front side;

FIG. 2 is a perspective view of the rough terrain crane as viewed from the left rear side;

FIG. 3A is a right side view illustrating a state where a jib in a boom is deployed;

FIG. 3B is a right side view illustrating a state where the jib in the boom is stored;

FIG. 3C is a left side view illustrating a state where the jib in the boom is stored;

FIG. 4A is a plan view of a deployed state corresponding to FIG. 3A, with the jib of the boom deployed;

FIG. 4B is a plan view of a stored state corresponding to FIGS. 3B and 3C, with the jib of the boom stored;

FIG. 5 illustrates a part of the right side surface of the crane indicating the disposition of an auxiliary power unit (APU);

FIG. 6 illustrates a part of the left side surface of the crane indicating the disposition of the APU;

FIG. 7 is a plan view of the crane illustrating the disposition of the APU; and

FIG. 8 is a cross-sectional view taken along line A-A in FIG. 5.

### DESCRIPTION OF EMBODIMENTS

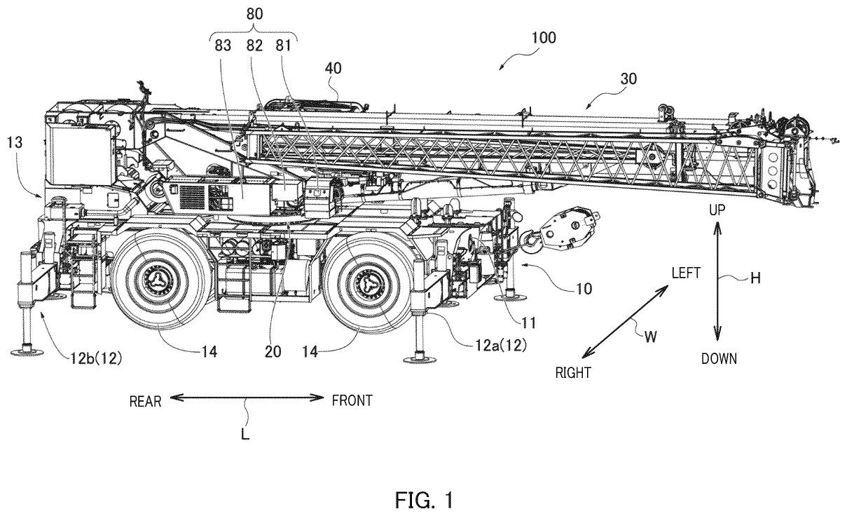

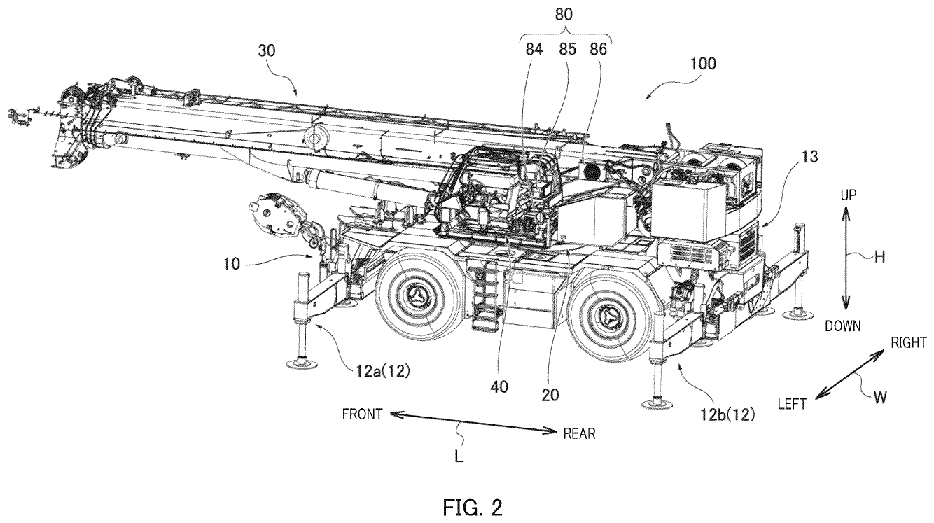

An embodiment of a crane vehicle according to the present invention will be described below with reference to the drawings. FIG. 1 is a perspective view of rough terrain crane 100 as viewed from the right front side. FIG. 2 is a perspective view of rough terrain crane 100 as viewed from the left rear side. The illustrated rough terrain crane 100 is an embodiment of the crane vehicle according to the present invention.

### Configuration

As illustrated in FIG. 1, rough terrain crane 100 (hereinafter, simply referred to as a crane 100) includes traveling apparatus 10, slewing base 20, boom 30, and a control room (cabin) 40. In addition, crane 100 includes auxiliary power unit 80 (APU) different from engine 13 for traveling or for crane work provided on traveling apparatus 10.

Traveling apparatus 10 is a vehicle body including equipment for traveling on the ground such as a road. Traveling apparatus 10 includes, on carrier frame 11 serving as the skeleton of the vehicle body, engine 13 that is a power source for traveling and for crane work using boom 30, wheels 14 for traveling that transmit power of engine 13 to the ground, outrigger 12 for improving stability during work, and the like.

Engine 13 corresponds to an example of a main power unit and is provided at a rear portion of carrier frame 11. Engine 13 is a power source when crane 100 travels or when the crane work using boom 30 is performed. When engine 13 is operating, a generator attached to engine 13 operates to generate, for example, power of a voltage of 48 V, and the generated power is used to operate an air conditioning apparatus (air conditioner) in cabin 40 or to supply power to an accessory component such as a universal serial bus (USB: registered trademark) terminal provided in cabin 40. Engine 13 and the generator may be regarded as an example of the main power unit. In this case, the power generated by the generator corresponds to an example of main power.

Outrigger 12 is composed of front outrigger 12a provided near front wheels 14 and rear outrigger 12b provided near rear wheels 14. Front outrigger 12a and rear outrigger 12b each extend outward in vehicle width direction W and touch the ground during the crane work, thereby stabilizing the posture of crane 100. Extension and retraction of outriggers 12 are also operated by the power generated by engine 13.

Wheels 14 for traveling are provided on the left and right sides of traveling apparatus 10 in vehicle width direction W and on the front and rear sides in front-rear direction L, between front and rear outriggers 12.

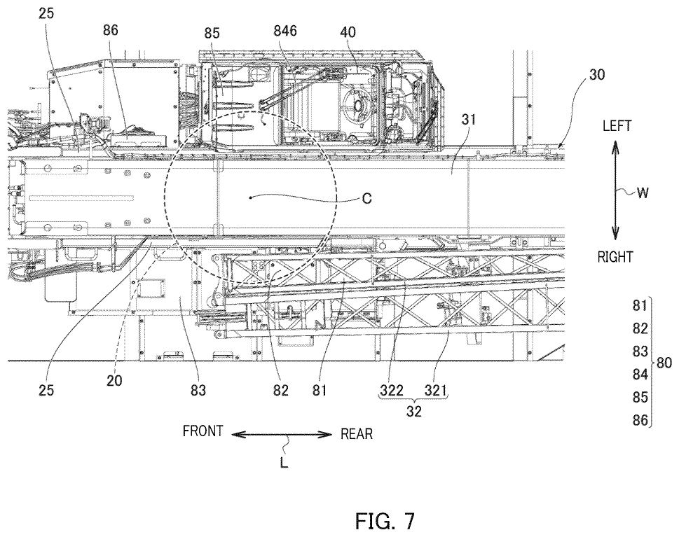

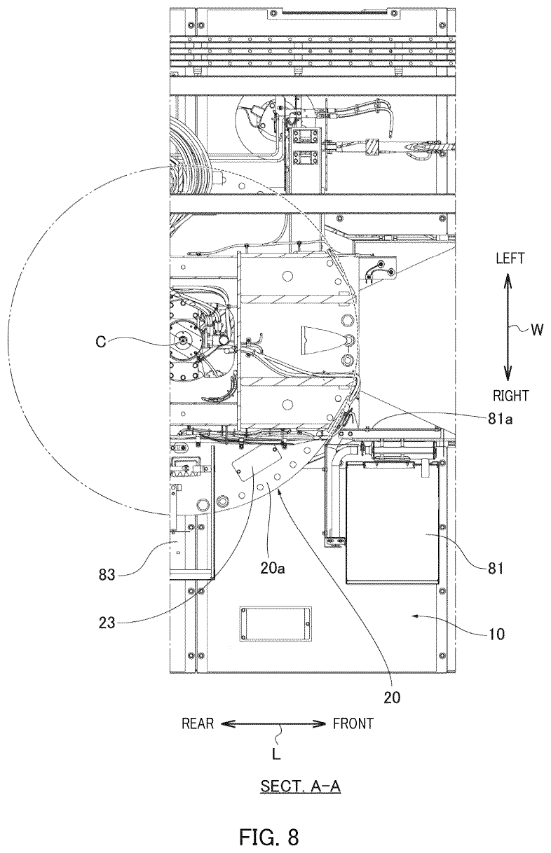

Slewing base 20 is disposed at a position that is above traveling apparatus 10, substantially the center in front-rear direction L, and the center in vehicle width direction W. Slewing base 20 is provided such that the center of traveling apparatus 10 in vehicle width direction W coincides with rotation center C (see FIGS. 7 and 8), and is provided to be rotatable about rotation center C with respect to traveling apparatus 10 in a horizontal plane. Slewing base 20 is driven and rotated by engine 13 provided in traveling apparatus 10.

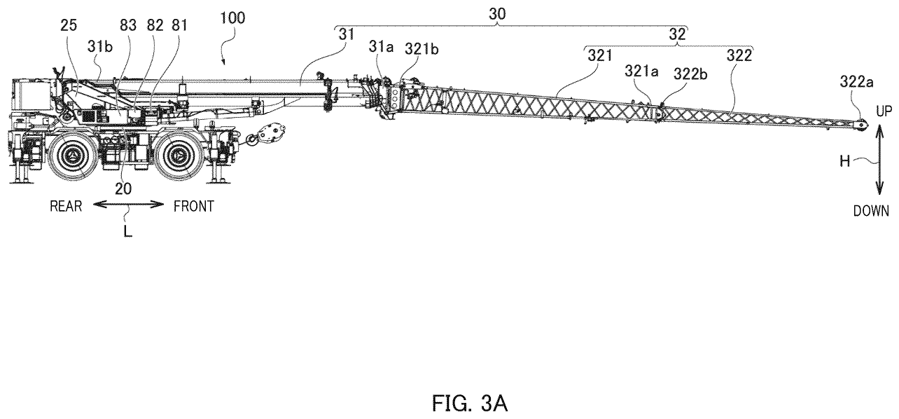

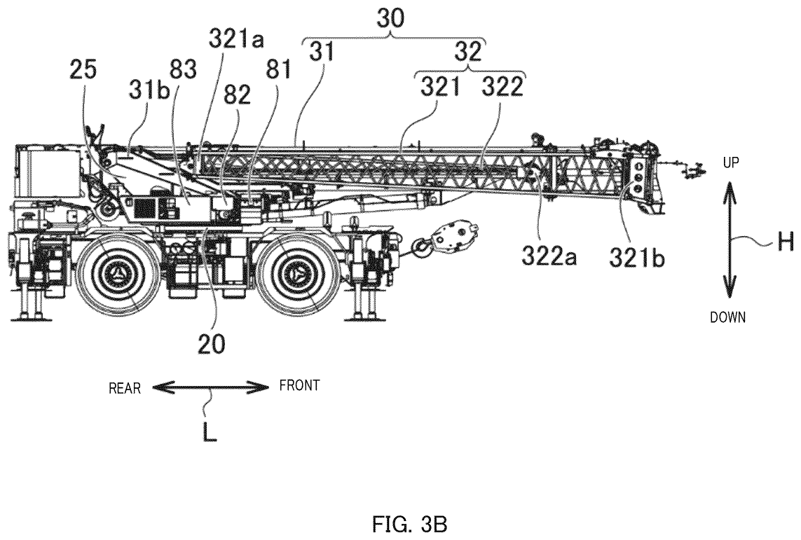

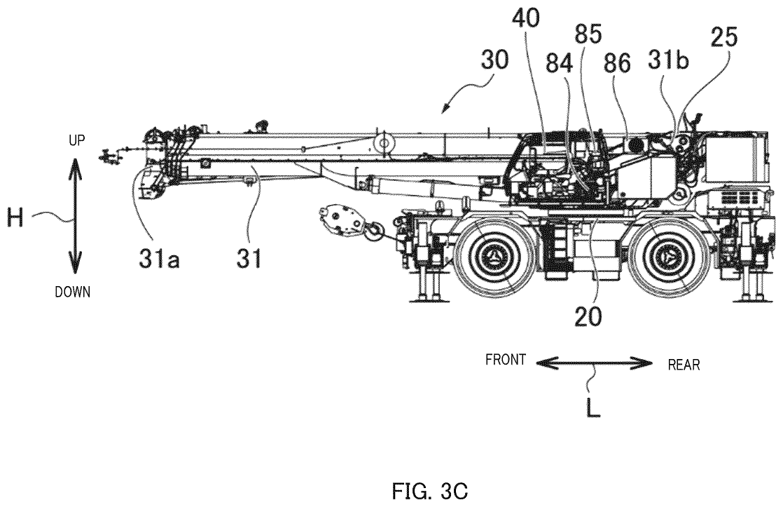

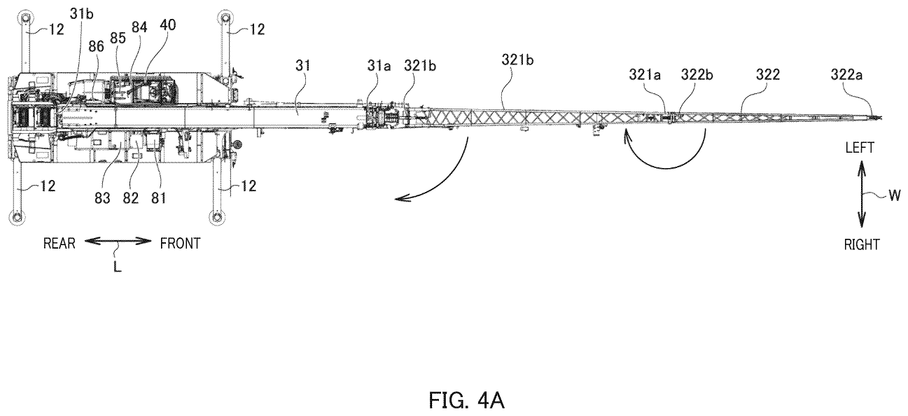

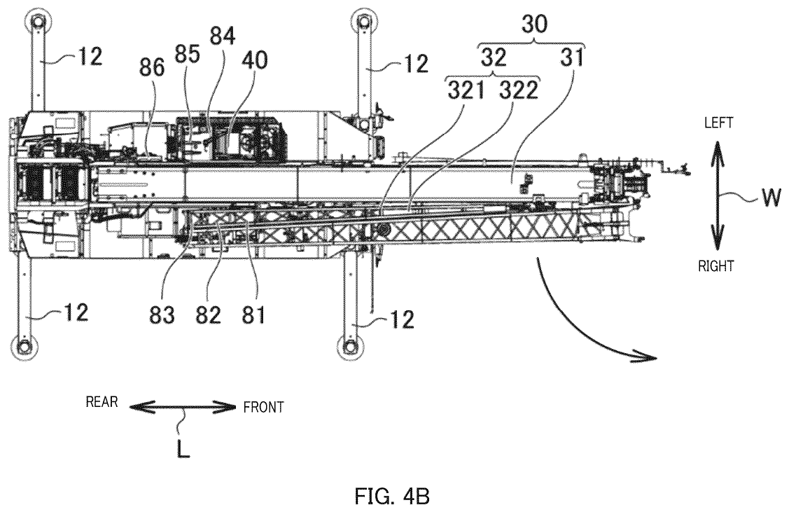

FIG. 3A is a right side view illustrating a state where jib 32 in boom 30 is deployed. FIG. 3B is a right side view illustrating a state where jib 32 in boom 30 is stored. FIG. 3C is a left side view illustrating a state where jib 32 in boom 30 is stored. In addition, FIG. 4A is a plan view of a deployed state corresponding to FIG. 3A, with jib 32 of boom 30 deployed. FIG. 4B is a plan view of a stored state corresponding to FIGS. 3B and 3C, with jib 32 of boom 30 stored.

Boom 30 and cabin 40 are provided on slewing base 20 and rotate with respect to traveling apparatus 10 integrally with slewing base 20. As illustrated in FIGS. 3A, 3B, 3C, 4A, and 4B, boom 30 includes telescopic boom 31 (basic boom) and jib 32.

Telescopic boom 31 is supported at its base end part 31b by base bracket 25 provided on slewing base 20, allowing the boom to luff. Base bracket 25 corresponds to an example of a bracket. The basic boom of the boom in the crane vehicle according to the present invention is not limited to the telescopic boom, and may be a non-telescopic boom. Telescopic boom 31 is disposed substantially at the center of crane 100 in vehicle width direction W. Cabin 40 is provided is provided leftward with respect to boom 30 in vehicle width direction W. Cabin 40 may be provided rightward with respect to boom 30 in vehicle width direction W.

Telescopic boom 31 extends and retracts between a shortened state where a plurality of booms are nested inside another boom and an extended state where each boom protrudes axially from another boom.

Jib 32 includes base end-side jib 321 and distal end-side jib 322. Base end part 321b of base end-side jib 321 is attached to distal end part 31a of a distal end boom in telescopic boom 31. Base end part 322b of distal end-side jib 322 is attached to distal end part 321a of base end-side jib 321. The jib of the boom in the crane vehicle according to the present invention is not limited to a jib composed of two base end-side jibs 321 and distal end-side jibs 322 such as jib 32 in the present embodiment, and may be composed of a single jib or three or more jibs.

Jib 32 is folded, from the deployed state illustrated in FIGS. 3A and 4A, along the right side of base end-side jib 321 by the following movement: distal end-side jib 322 of jib 32 rotates in the clockwise direction in a plan view as indicated by an arrow in FIG. 4A with a portion of distal end-side jib 322 attached to base end-side jib 321 as the rotation center.

In addition, jib 32 reaches the stored state by the following movement: with distal end-side jib 322 is folded, base end-side jib 321 rotates in the clockwise direction in a plan view as indicated by an arrow in FIG. 4A with a portion of base end-side jib 321 attached to telescopic boom 31 as the rotation center, so that jib 32 is folded along the right side of telescopic boom 31 with distal end-side jib 322 interposed inbetween as illustrated in FIGS. 4B, 3B, and 3C.

In the crane vehicle in which cabin 40 is provided rightward with respect to boom 30, jib 32 is folded along the left side of the basic boom in the stored state. That is, in the stored state, the jib is disposed along a side of the basic boom opposite to a side on which the control room is provided in the vehicle width direction. In other words, in the stored state, jib 32 is disposed laterally with respect to boom 30 in a half portion of the crane vehicle-the half portion is located opposite to cabin 40.

Jib 32 reaches the deployed state illustrated in FIGS. 3A and 4A from the stored state illustrated in FIGS. 3B, 3C, and 4B by swinging base end-side jib 321 to the right side in the counterclockwise direction in a plan view and further swinging distal end-side jib 322 to the right side in the counterclockwise direction in a plan view. Then, boom 30 can be further extended from the state illustrated in FIGS. 3A and 4A by extending telescopic boom 31 in the deployed state of jib 32.

### APU

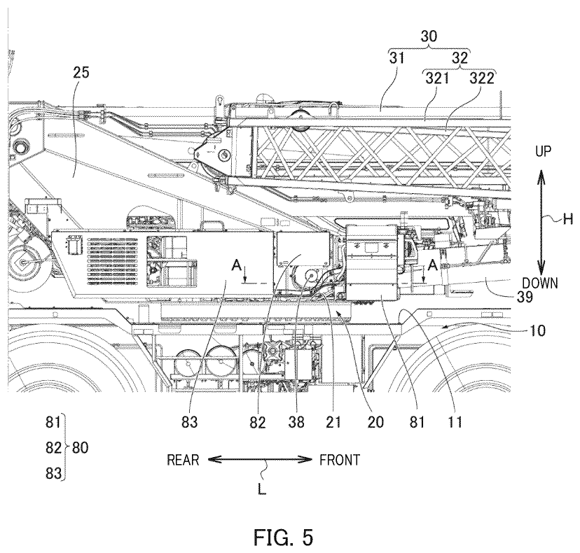

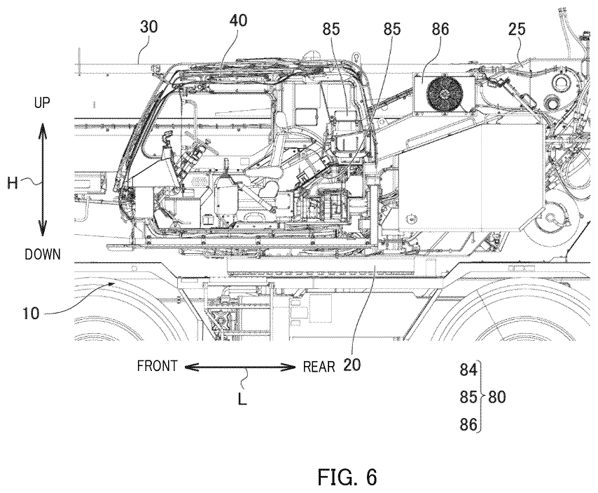

FIG. 5 illustrates a part of the right side surface of crane 100 indicating the disposition of APU 80. FIG. 6 illustrates a part of the left side surface of crane 100 indicating the disposition of APU 80. FIG. 7 is a plan view of crane 100 illustrating the disposition of APU 80. FIG. 8 is a cross-sectional view taken along line A-A in FIG. 5.

Engine 13 provided in traveling apparatus 10 is stopped when crane 100 does not travel and does not perform the crane work, thereby reducing the fuel consumption of engine 13 and the emission of carbon dioxide from engine 13. The operation of engine 13 may be automatically controlled by a control section or may be manually controlled by an operator.

APU 80 provides power mainly used in cabin 40 during a period in which engine 13 is stopped, and supplies power to an air conditioning apparatus in cabin 40 and an accessory component such as a universal serial bus (USB: registered trademark) terminal provided in cabin 40. Therefore, APU 80 is provided not on traveling apparatus 10 but on slewing base 20 or on base bracket 25 or cabin 40 that rotates together with slewing base 20.

APU 80 includes, for example, body 81, electrical system component 82 composed of a battery and a DC-DC converter, fuel tank 83, APU controller 84, evaporator 85, and condenser 86.

Body 81 corresponds to an example of an auxiliary power source. Body 81 is an engine as an example, but is not limited to the engine as long as body 81 is a power source generating power. Specifically, in place of the engine, body 81 may be a storage battery, a power receiving and outputting unit that receives electric power from the outside and outputs the power, or the like. The engine (hereinafter, referred to as a sub-engine) as body 81 is smaller than engine 13 provided in traveling apparatus 10, has a smaller fuel consumption (for example, fuel consumption per unit output), and has higher efficiency in fuel consumption (better fuel economy) than engine 13. That is, body 81 is a device different from engine 13 provided in traveling apparatus 10.

Fuel tank 83 is a tank that stores fuel for driving the sub-engine. Therefore, when body 81 is not an engine and thus does not require fuel, fuel tank 83 may be omitted. In addition, a tank that stores fuel for driving engine 13 provided in traveling apparatus 10 is provided in traveling apparatus 10 separately from fuel tank 83. When the fuel in the fuel tank provided in traveling apparatus 10 is supplied to the sub-engine to drive the sub-engine, fuel tank 83 may be omitted.

The battery in electrical system component 82 starts the engine (hereinafter, referred to as a sub-engine) as body 81 and is charged by storing electricity generated during the driving of the sub-engine. The DC-DC converter in electrical system component 82 boosts the voltage of the power generated by the sub-engine to the voltage of the power generated by engine 13. The DC-DC converter corresponds to an example of a boosting unit. In addition, the power generated by the sub-engine corresponds to an example of auxiliary power.

Since the voltage of the power generated by engine 13 provided in traveling apparatus 10 is set to, for example, 24 [V], an electrical device such as an air conditioning apparatus or a USB (registered trademark) power supply equipped in cabin 40 is set to operate at a voltage of 24 [V]. On the other hand, since the voltage of the power generated by the sub-engine is set to, for example, 12 [V], the power having the voltage of 12 [V] cannot be used as it is for the electrical devices equipped in cabin 40.

The DC-DC converter in electrical system component 82 boosts the voltage of the power generated by the sub-engine to the voltage of the power generated by engine 13. Therefore, when the voltage of the power generated by the sub-engine is the same as the voltage of the power generated by engine 13, the DC-DC converter in electrical system component 82 is not provided.

As illustrated in FIGS. 5 and 7, body 81, electrical system component 82, and fuel tank 83 described above are located rightward with respect to telescopic boom 31 in vehicle width direction W. Body 81, electrical system component 82, and fuel tank 83 are fixed to slewing base 20 directly or via base bracket 25 that rotates together with slewing base 20. In addition, each of body 81, electrical system component 82, and fuel tank 83 is covered with a cover for protection from wind and rain and disposed. Then, as illustrated in FIGS. 5 and 7, body 81, which is a main constituent element (an essential constituent element that cannot be not omitted) of APU 80, is disposed in the following space: a space that is below jib 32 in the stored state of boom 30 (telescopic boom 31 is in a lowered state and jib 32 is in the stored state) and coincides with jib 32 in a plan view.

Here, as illustrated in FIG. 8, body 81 is provided on slewing base 20 via support bracket 81a. In a plan view illustrated in FIG. 8, body 81 is disposed outside slewing base 20. For this reason, in a plan view, body 81 does not overlap with slewing base 20. Accordingly, in a plan view from the upper surface 20a side, body 81 does not overlap with inspection cover 23 covering an inspection port that is provided for maintenance and is formed on upper surface 20a of slewing base 20. The inspection port is a window for performing, by an operator, inspection, tightening-up, or the like of bolts that fix slewing base 20 (a plurality of bolts provided along an outer peripheral portion of the slewing base and arranged in a circumferential direction). With this configuration, maintainability of work such as the bolt tightening-up from above slewing base 20 by detaching and attaching inspection cover 23 is not impaired.

On the other hand, since body 81 does not overlap with slewing base 20 in a plan view, as illustrated in FIG. 5, a portion below body 81 is not blocked by slewing base 20, and thus a predetermined space remains between a lower surface of body 81 and carrier frame 11 of traveling apparatus 10. As a result, maintenance of body 81 can be performed (for example, a filter of the sub-engine can be attached and detached) from the remaining space below body 81, and thus the maintainability of body 81 is not impaired.

In the present embodiment, electrical system component 82, which is not the main configuration of APU 80, is also disposed in the space, which is below jib 32 in the stored state and coincides with jib 32 in a plan view. Further, in the present embodiment, fuel tank 83, which is not the main configuration of APU 80, is also disposed in the space, which is below jib 32 in the stored state and coincides with jib 32 in a plan view.

Then, as illustrated in FIG. 7, electrical system component 82 and fuel tank 83 overlap with slewing base 20 in a plan view. On the other hand, as illustrated in FIG. 5, electrical system component 82 is provided away from slewing base 20 at a position above the slewing base. For this reason, a space that allows performing of maintenance by attaching and detaching inspection cover 23 (see FIG. 8) is provided above inspection cover 23. Accordingly, electrical system component 82 and fuel tank 83 do not impair the efficiency of the maintenance performed by attaching and detaching inspection cover 23. In other words, APU 80 is provided above inspection cover 23 via a space for maintenance of slewing base 20.

In addition, as illustrated in FIG. 5, a space that allows performing of maintenance of support pin 38 (grease supply to support pin 38 or the like) is provided on the right side of support pin 38 along vehicle width direction W-through support pin 38, luffing cylinder 39 that raises and lowers boom 30 is supported on base bracket 25. For this reason, the disposition of electrical system component 82 does not impair the maintainability of support pin 38.

APU controller 84, evaporator 85, and condenser 86 constitute an air conditioning apparatus for cabin 40 using the sub-engine as a power source. As the air conditioning apparatus for cabin 40, an air conditioning apparatus using engine 13 provided in traveling apparatus 10 as a power source is separately provided. That is, crane 100 includes an air conditioning apparatus (main air conditioner) using engine 13 provided in traveling apparatus 10 as a power source and an air conditioning apparatus (sub-air conditioner: APU controller 84, evaporator 85, and condenser 86) using the sub-engine as a power source. The air conditioning apparatus using engine 13 as a power source corresponds to an example of a main electronic device. In addition, the air conditioning apparatus using the sub-engine (in other words, APU 80) as a power source corresponds to an example of an auxiliary electronic device.

The air conditioning apparatus (specifically, APU controller 84) for cabin 40 selects the main air conditioner when engine 13 is driven. On the other hand, the air conditioning apparatus (specifically, APU controller 84) for cabin 40 selects the sub-air conditioner when engine 13 is stopped. Then, the selected air conditioning apparatus conditions air in cabin 40. The selection of the air conditioner is switched by APU controller 84. APU controller 84 corresponds to an example of a control section. According to a state of engine 13, APU controller 84 selects a power unit that supplies power to the electronic device (specifically, the air conditioning apparatus) from the main power unit (specifically, engine 13) and the auxiliary power unit (specifically, APU 80). Specifically, APU controller 84 selects the main power unit (specifically, engine 13) as the power device that supplies power to the air conditioning apparatus while engine 13 is driven. On the other hand, APU controller 84 selects the auxiliary power unit (specifically, APU 80) as the power apparatus that supplies power to the air conditioning apparatus while engine 13 is stopped.

In the present embodiment, APU controller 84, evaporator 85, and condenser 86, which are not the main configuration of APU 80, are disposed leftward with respect to boom 30, in the same manner as cabin 40. That is, APU controller 84, evaporator 85, and condenser 86 are not disposed in the space below jib 32 in the stored state.

As described above, it is preferable that APU controller 84, evaporator 85, and condenser 86 are disposed near cabin 40 in order to perform air conditioning inside cabin 40. In particular, since evaporator 85 is a heat exchanger in cabin 40, evaporator 85 is disposed in cabin 40 as illustrated in FIGS. 6 and 7. In addition, since APU controller 84 includes electronic components, it is necessary that APU controller 84 is not exposed to moisture such as rain or snow and is not exposed to outside air that may reach to a high temperature. Therefore, APU controller 84 is disposed in cabin 40 together with evaporator 85.

APU controller 84 performs switching of the selection of the air conditioning apparatus, control of driving of body 81, control of driving of a pump of fuel tank 83, control of an operation of the electrical system component (the DC-DC converter and the battery) 82, and control of supplying power to an accessory component such as the USB (registered trademark) terminal provided in cabin 40 (accessory power supply).

Condenser 86 performs heat exchange that is opposite to the heat exchange required in cabin 40, and thus condenser 86 should be disposed outside cabin 40. In the present embodiment, as illustrated in FIGS. 6 and 7, condenser 86 is fixed to base bracket 25 behind cabin 40.

As described above in detail, when engine 13 provided in traveling apparatus 10 is stopped, crane 100 of the present embodiment can supply, by APU 80, necessary power to the air conditioning apparatus or the accessory power supply in cabin 40 attached to slewing base 20.

Therefore, with crane 100 of the present embodiment, it is possible to use a device provided on the slewing base even in a state where the engine for traveling and for crane work is stopped, while reducing the fuel consumption and the environmental load.

In addition, in a state in which jib 32 of a swing-out type in the lateral direction is stored, crane 100 of the present embodiment includes body 81 (which is at least a main configuration of APU 80) at slewing base 20 or at a portion that rotates integrally with slewing base 20 in a space below jib 32. Since APU 80 is provided in an existing dead space, crane 100 does not need to newly provide a space for disposing APU 80.

In crane 100 of the present embodiment, in addition to body 81 (which is a main configuration of APU 80), electrical system component 82 and fuel tank 83 (which are not main configurations) are also disposed at slewing base 20 or a portion that rotates integrally with slewing base 20 in the space below jib 32 in the stored state. However, in the crane vehicle according to the present invention, at least the main configuration (power source) of the auxiliary power unit is disposed at the slewing base or a portion that rotates integrally with the slewing base in a space below the jib in a stored state of the jib of a swing-out type in the lateral direction.

Crane 100 of the present embodiment is provided with electrical system component 82 and fuel tank 83 in addition to body 81 at slewing base 20 or a portion that rotates integrally with slewing base 20 in the space below jib 32 in the stored state. For this reason, at least a part of the components of APU 80 can be disposed in one place.

In crane 100 of the present embodiment, since APU 80 does not overlap with inspection cover 23 of slewing base 20 in a plan view, it is possible to prevent the maintainability of work such as the above-described bolt tightening-up from being impaired by attaching and detaching inspection cover 23.

In addition, in crane 100 of the present embodiment, body 81 of APU 80 does not overlap with slewing base 20 in a plan view and a predetermined space is formed below body 81, and therefore, it is possible to prevent the maintainability of body 81 from being impaired.

In addition, in crane 100 of the present embodiment, a predetermined space is ensured on the right side of support pin 38 of luffing cylinder 39 along vehicle width direction W, it is possible to prevent the maintainability of support pin 38 from being impaired.

Crane 100 of the present embodiment is an example in which at least body 81 is disposed in the space, which is below jib 32 in the stored state and coincides with jib 32 in a plan view, but the at least body 81 may be disposed in a space on an extension line of jib 32 in the stored state or a space that is below the extension line of jib 32 in the stored state and coincides with the extension line in a plan view.

That is, when jib 32 is considerably shorter than telescopic boom 31, on the side of telescopic boom 31, there is a space on the extension line of jib 32 or below the extension line of jib 32—the space in which body 81 and the like can be disposed. Therefore, the crane vehicle according to the present invention includes a crane vehicle in which body 81 and the like are disposed in a space on the extension line of jib 32 or in a space below the extension line of jib 32.

In practice, from the viewpoint of ensuring lateral visibility from cabin 40, it is preferable that body 81 and the like are disposed in a space below the line of the lower end of a side window of cabin 40 in the space below the extension line of jib 32.

In crane 100 of the present embodiment, crane 100 includes jib 32 of a swing-out type in the lateral direction, and the main configuration of APU 80 is disposed in a space below jib 32 in the stored state. However, the crane vehicle according to the present invention is not limited to a crane vehicle including the jib of a swing-out type in the lateral direction.

That is, when the crane vehicle according to the present invention does not include a jib of a swing-out type in the lateral direction as the boom but includes a structure such as a hose reel on a side of the basic boom opposite to a side on which cabin 40 is provided in vehicle width direction W, body 81 and the like may be disposed in a space that is below the structure such as the hose reel and coincides with the structure in a plan view.

In this case as well, from the viewpoint of ensuring the lateral visibility from cabin 40, it is preferable that body 81 and the like are disposed in a space below the line of the lower end of the side window of cabin 40 in the space below the structure.

This application is entitled to and claims the benefit of Japanese Patent Application No. 2022-192928 filed on Dec. 1, 2022, the disclosure of which including the specification, drawings and abstract is incorporated herein by reference in its entirety.

### INDUSTRIAL APPLICABILITY

The present invention can be applied to various crane vehicles.

### REFERENCE SIGNS LIST

10 Traveling apparatus
11 Carrier frame
12 Outrigger
12a Front outrigger
12b Rear outrigger
13 Engine
14 Wheel
20 Slewing base
20a Upper surface
23 Inspection cover
25 Base bracket
30 Boom
31 Telescopic boom
31a Distal end part
31b Base end part
32 Jib
38 Support pin
39 Luffing cylinder
40 Cabin
80 Auxiliary power unit (APU)
81 Body
81a Support bracket
82 Electrical system component
83 Fuel tank
84 APU controller
85 Evaporator
86 Condenser
100 Rough terrain crane (crane vehicle)
321 Base end-side jib
321a Distal end part
321b Base end part
322 Distal end-side jib
322b Base end part
C Rotation center
L Front-rear direction
W Vehicle width direction

1. A crane vehicle comprising:
a traveling apparatus;
a slewing base supported by the traveling apparatus;
a main power unit provided on the traveling apparatus, the main power unit being for traveling and for crane work; and
an auxiliary power unit supported by the slewing base, the auxiliary power unit supplying power to an electronic device supported by the slewing base.

2. The crane vehicle according to claim 1, wherein:
the main power unit includes an engine and supplies power to the electronic device while the engine is driven; and
the auxiliary power unit supplies power to the electronic device while the engine is stopped.

3. The crane vehicle according to claim 2, further comprising:
a control section that selects a power unit that supplies power to the electronic device from the main power unit and the auxiliary power unit according to a state of the engine.

4. The crane vehicle according to claim 2, wherein
a voltage of the power output by the auxiliary power unit is equal to a voltage of the power output by the main power unit.

5. The crane vehicle according to claim 2, wherein:
a voltage of auxiliary power output by the auxiliary power unit is lower than a voltage of main power output by the main power unit; and
the auxiliary power unit includes a boosting unit that boosts the voltage of the auxiliary power to a value identical with the voltage of the main power.

6. The crane vehicle according to claim 2, wherein
the electronic device includes
a main electronic device using main power output by the main power unit as a power source, and
an auxiliary electronic device using auxiliary power output by the auxiliary power unit as a power source.

7. The crane vehicle according to claim 1, further comprising:
a control room provided on the slewing base, wherein
the auxiliary power unit includes an auxiliary power source provided in a half portion of the crane vehicle, the half portion being located opposite to the control room in a vehicle width direction.

8. The crane vehicle according to claim 7, further comprising:
a boom supported by the slewing base; and
a jib that is disposed, in a stored state, laterally with respect to the boom and in the half portion located opposite to the control room, wherein
the auxiliary power source is disposed below the jib in the stored state.

9. The crane vehicle according to claim 7, further comprising:
a boom supported by the slewing base; and
a jib that is disposed, in a stored state, laterally with respect to the boom and in the half portion located opposite to the control room, wherein
the auxiliary power source is disposed in a space on an extension line of the jib in the stored state or in a space that is below the jib in the stored state and coincides with the extension line of the jib in the stored state in a plan view.

10. The crane vehicle according to claim 1, wherein:
the slewing base includes, on an upper surface thereof, an inspection cover; and
the auxiliary power unit is provided above the inspection cover via a space for maintenance of the slewing base.

11. The crane vehicle according to claim 1, further comprising:
a boom supported by the slewing base;
a bracket through which the boom is supported on the slewing base;
a luffing cylinder that raises and lowers the boom; and
a support pin through which the luffing cylinder is supported on the bracket, wherein
the auxiliary power unit is provided laterally with respect to the support pin via a space for maintenance of the support pin.

12. The crane vehicle according to claim 1, wherein
the auxiliary power unit includes an auxiliary power source that is disposed outside the slewing base and does not overlap with the slewing base in a plan view; and
a space for maintenance of the auxiliary power source is provided below the auxiliary power source.
